(19) United States
(12) Patent Application Publication
(10) Pub. No.: US 2017/0212478 A1
(43) Pub. Date: Jul. 27, 2017

(54) Wristwatch device with time management function for displaying a schedule in the wristwatch device

(71) Applicant: WHAT WATCH AG, Zürich (CH)

(72) Inventors: Igor Basargin, Ekaterinburg (RU); Masashi Kawamura, Tokyo (JP)

(73) Assignee: WHAT WATCH AG, Zürich (CH)

(21) Appl. No.: 15/328,077

(22) PCT Filed: Jul. 22, 2015
(86) PCT No.: PCT/IB2015/055545

§ 371 Date: Jan. 23, 2017

(30) Foreign Application Priority Data
Jul. 23, 2014 (IB) PCT/IB2014/063341

(51) Int. Cl. G04G 9/00; G06F 3/044; G04G 21/08; G06Q 10/10; G04G 21/04; G04G 19/00

(52) U.S. Cl. CPC G04G 9/0064; G04G 21/04; G04G 19/00; G04G 21/08; G06Q 10/1095; G06F 3/044

(57) ABSTRACT

A wristwatch device with a time management function for displaying a schedule in the wristwatch device comprising a data communication device for receiving time management data from an outer device comprising database of time management data. The wristwatch device comprises also a display device having indication means, e.g. segments for indicating periods of time or timely arranged events, like calendar bookings. Further the wristwatch device comprises also a data controlling unit configured to read said received time management data and thereby manipulate said indication means of the display device in order to indicate events of time based on said received time management data.”

### TECHNICAL FIELD OF THE INVENTION

The invention relates to a wristwatch device and a method for providing a wristwatch device with time management function for displaying a schedule in the wristwatch device. Especially the invention relates to a time management function of the wristwatch device, where the time management function comprises a calendar or tasks-list follow-up function, as an example.

### BACKGROUND OF THE INVENTION

Plurality of different time management devices are known from prior art, such as electronic calendars managed by mobile phones, computers or computer network applications. Typically these applications show bookings via different markings and notifications, such as via colour coded boxes or areas in the application, when the application is operated.

There are however some disadvantages relating to the known prior art, such as they are quite cumbersome and time consuming to use. In order to have even a general view of the time management data, such as calendar bookings, the user must open the suitable application or device. However also different kinds of reminder functions are known, where the application makes an alarm, such as noise alarm, sound or vibration just before the next event. Still there is a problem to easily see the longer period time management data and have easy, instant access to the data, such as calendar bookings or other events in near future, such as during current day.

### SUMMARY OF THE INVENTION

An object of the invention is to alleviate and eliminate the problems relating to the known prior art. Especially the object of the invention is to provide a device and method with a time management function for displaying a schedule in the wristwatch device so that next tasks, bookings, meetings or other schedule events can be easily seen or otherwise recognized and/or accessed by a user without specifically opening or operating any application or device, such as opening a calendar application or the like.

The object of the invention can be achieved by the features of independent claims.

The invention relates to a wristwatch device with a time management function for displaying a schedule in the wristwatch device according to claim 1. In addition the invention relates to a method for providing a wristwatch device with a time management function for displaying a schedule in the wristwatch device according to claim 21, as well as a computer program product according to claim 22.

According to an embodiment of the invention a wristwatch device with a time management function for displaying a schedule in the wristwatch device comprises a data communication device for receiving time management data, such as calendar data or tasks-list follow-up data, from an outer device comprising database of time management data. The outer device may be for example a mobile terminal, such as mobile phone, smartphone, tablet computer, laptop computer, computer, wireless router, server or cloud based server, for example. The outer device advantageously comprises said time management data, for example calendar data in electronic form. One example is an online calendar or task list holding computer program, such as Outlook, Google or Yahoo calendars, which can advantageously configured to be manipulated via a network browser, certain program or application. According to an example several different calendars can be managed simultaneously, which is very convenient feature for example if the user has several different calendars, such as a calendar for work and another for leisure time. The application may e.g. reshape the data, so it is made suitable for use with the wristwatch device. As an example the time management function is a function for displaying schedule data received from the outer device (from an application advantageously run on the outer device) in the wristwatch device or providing tactile indication (like alarm), such as vibration about an upcoming event (booked time period). In relation to an alarm options may be e.g. to reset time interval or skip the reminder (alarm), which can be performed via user interface. The time management function may process the received data into a form suitable for the display of the wristwatch device.

In addition the wristwatch device comprises also a display device having indication means for indicating periods of time or timely arranged tasks of calendar bookings for example. According to an embodiment the indication means are implemented by segments, icons, number, text or combination of the said. According to an embodiment they are not used for showing time as such, but the wristwatch device may have additionally mechanical or digital hands for showing the current time. Furthermore the wristwatch device comprises also a data controlling unit configured to read the received time management data so events in time and thereby control the indication means, such as segments of the display device in order to indicate said schedule events in time, such as booked periods of time based on said received time management data.

It is to be noted that the icons can be used for visualising different natures of the events or other action, such as home, work, hobby or the like. In addition according to an example the users may manipulate and create different types of icons for their wristwatch devices (as well as other data) and couple the icons with different types of natures of events. Furthermore it is to be noted that according to an example the wristwatch device may also display several types of segments, such as one type for busy time and one for leisure time, but also combination of them. Still according to an example different colors or gray scales can be used and displayed for different or overlapping or adjacent schedule events in order to make clearer difference between the different events.

The data communication device comprises advantageously a wireless data communication device implemented e.g. with Bluetooth, WIFI, 3G/4G, NFC, data modulated visible light, infra-red technologies, but also wired data communication device can be used. The data communication device is advantageously configured to establish a single or bi-directional data communication link between said wristwatch device and the outer device in order to receive time management data, for example. The outer device runs advantageously the application, via which the data as well as controlling commands e.g. to control the display showing parameters can be managed by the user and send to the wristwatch.

According to an embodiment the wristwatch device comprises also a user interface for controlling to operation of the wristwatch. One of the main ideas is to use the operational steps as simple as possible and the user interface may comprise a button, wheel or rotating bezel, touch surface, dedicated touch sensor, such as capacitive touch panel or other types of sensors (e.g. accelerometer or gyro), which are coupled with a pre-programmed function. The wristwatch device is thus configured to perform the pre-programmed function when the user interface is manipulated, such as the button is pressed, wheel is turned or touch sensors is touched (activated or tapped e.g. twice or the like), or when other sensors detect or measure any incident, such as acceleration (shaking or tapping the device) or certain coordinates (positioning device, gyro). The pre-programmed function may be e.g. a pre-programmed message, such as an “Accept” or “Decline” message as an answer to the outer device comprising the database of time management data if proposals can be sent to the wristwatch device, such as proposal of time slot booking, which can either be accepted or declined. In addition also the schedule pattern can be changed to display e.g. next 12 hours or 24 hours, for example when the user interface is manipulated. As an example the screen display may be go back to the original screen display or pattern after predetermined time period.

According to an embodiment the wristwatch device may also comprise a control wheel or rotating bezel arranged around the display, where it can be used for controlling the operations of the device. The wristwatch device may comprise an angle sensor for determining the angle of the wheel or rotating bezel turned, whereupon the data controlling unit advantageously determined selected period of time, for example, and indicates it via the display device.

For example a range or period to be displayed can be selected by rotating the wheel (or bezel). The period to be shown may be for example 12 hours or 24 hours, but also other range lengths can naturally be used and selected. According to an example when the wheel is rotated the watch detects the movement angle of the wheel and updates the display so that the selected length of the period is displayed starting from the point indicated by the wheel, for example the next 12 hour range.

According to an example the range or period to be displayed can be selected by tapping the screen display. The screen display can be implemented by a touch screen (e.g. by a capacitive touch panel), whereupon the touch screen detects the tapping. Alternatively or in addition the wristwatch may comprise accelerometer or microphone or other suitable device for detecting the tapping, whereupon the wristwatch can detect the tapping by the accelerometer or microphone or the like. The different number of tapping may indicate different parameters, such as should the schedule pattern be changed to 12 or 24 hours display or to go back to the original display. The tapping is very convenient, easy, accurate and fast way to give user input. In many cases it is also very safe way, because there is no need for user to even look at the display or otherwise to focus to the wristwatch.

According to an example the periods to be displayed, such as 12 or 24 hours, can be determined via an application, which communicates them to the wristwatch. It should be noted that the period can of course varied and also selected freely by the user e.g. via the application. According to an embodiment the wristwatch device displays a predetermined period, such as next 12 hours, which is advantageously counted from the current watch hand. According to an example the wristwatch device may display for example the next 12 hours counted from the end of previous predetermined period, when tapped on the screen of otherwise manipulated the user interface. For example if the period ends at 21.00 then the next 12 hours are shown from 21.00 to 9.00, even when it is 19.00 at the time of tapping.

As an example the user can predetermine by the application from which starting point the schedule shall be displayed on the wristwatch device, such as e.g. it can be chosen that the wristwatch device displays occupancy from 9 a.m. to 9 p.m. or 12 a.m. to 12 p.m. or other. It is to be noted that also other parameters for controlling the wristwatch display can be managed via the application and send to the wristwatch via the outer device.

Typically the data transfer link between the outer device or application and the wristwatch is one way link so that the data to be displayed by the wristwatch is transferred from the application. However, according to an optional and exemplar embodiment a period of time can also be booked by manipulating e.g. said control wheel or by tapping or by using both. The start of the period of time can be selected by the wheel and marked e.g. by pressing a button, and the extent of the period and stop of the period may be advantageously selected by turning the wheel and marked by pressing the button, such as e.g. beginning and the end of the upcoming event or task. When the period of time is marked and selected, it can be sent to the outer device comprising the database of time management data (for synchronization purposes).

The display device may be implemented for example with an electrophoretic ink paper display (E-ink display), monochromatic display, grey-scale display, full colour, a reflective, transflective or transmissive TFT display (Thin-Film-Transistor display), or OLED display (Organic Light-Emitting Diode), or microelectromechanical systems (MEMS) display comprising e.g. a mirror structure or relief structure controlled via an electromagnetic technique, for example, or a projector. The display device may also comprise a capacitive touch screen whereupon a period of time for a calendar or task can be booked or displayed via manipulating said capacitive touch screen, such as tapping it. It is to be noted that the tapping can also be determined by the acceleration sensor. Touch surface can be also located on the surface or placed (integrated) inside the window glass of the wristwatch.

According to an embodiment the display device may be as a reflective display device comprising microscopic mirrors (“MEMS”) in each pixel changing the size of an air gap inside the display so that depending on the size of the gap, white light is reflected back as red, green or blue, for example. The reflective display is based on interferometric modulation, where each pixel comprises sub-pixels, and where each sub-pixel mirror opens to only one colour stage, whereupon the colour of the pixel is combination of colours of sub-pixels.

Additionally the wristwatch device may also comprise a quartz or mechanical movement and an axis for the movement (calibre) arranged through a hole in the display device. The first end of the pin axis is advantageously connected to the quartz or mechanical movement and the second free end is provided for hands of the wristwatch device.

According to an embodiment the data controlling unit is configured to manipulate and control the indication means, like segments, icons, numbers or text of the display device differently for different levels of booking or other events, such as comprising working bookings, timely tasks assignment, leisure-time bookings or priority bookings, in order to indicate different booked periods differently. Also different events with higher or different priorities may be displayed or indicated in the different colours (having also black and white as well as naturally also other colours) or different grey-scale level or different pattern for example pre-defined by the user.

In addition the wristwatch device comprises also an energy source, which can be e.g. primary (non-rechargeable) battery, or a chargeable battery, or a supercapacitor. According to an example a wireless charger, based on e.g. induction or other known technique can be used to charge the energy source of the wristwatch. According to an embodiment the wristwatch device comprises an induction device configured to be coupled with an external induction coil energy charging system, whereupon the wristwatch device is configured to charge said battery via induction. In addition according to an embodiment the wristwatch device may also comprise a re-chargeable battery and energy harvesting device, such as solar cell, thermal element or induction device configured to harvest energy from the light, temperature difference or motion, such as harvest energy from hand movement wearing the wristwatch device, whereupon the wristwatch device is configured to powering the device and/or charge said battery via such harvesting device or their combination.

Still according to an example the wristwatch device may be configured to display the next 12 hours or 24 hours bookings at a time. Of course also other periods can be selected.

In addition, according to an exemplary embodiment the wristwatch device may comprise so called inner and outer displays. Advantageously they are implemented by controlling the view of the display device so that inner and outer displays are displayed alternately or at the same time for example side by side. Displaying alternately may be done either automatically after few seconds, for example, or changing between the inner and outer display manually e.g. by pressing a button. The inner display may visualize e.g. time management or schedule events of the hole day (or other time range), and the outer display may visualize the time running within or to a certain meeting or event, whereupon the user can easily see time left before the start or end of the event.

According to an embodiment the wristwatch device is configured to be synchronized with the outer device advantageously so that at least one day or one week data or other period (e.g. 24 hours) data is synchronized at a time. Advantageously the synchronization is configured to happen only if the calendar data at the database for the period in question has changed after previous synchronization, by which a data transferred can be minimized and battery life time can be extended. The synchronization can also be configured to happen every time when the wristwatch detects the outer device or automatically each pre-set time interval, such as in every 15 minutes and is initialized by the outer device (advantageously by the application).

It is to be noted that the wristwatch is intended, according to an embodiment, to display schedule data on the watch dial in correlation to the day time displayed with analogue watch face. According to an embodiment the dial has advantageously 48 segments, so one segment corresponding 15 minutes. The watch hands can be controlled by the application and the wristwatch device displays e.g. 12 hours (00-12) or user setting period, e.g. 9-21. While objective time passes the hands may “consume” the past time, for example.

The present invention offers advantages over the know prior art, such as easy, very fast and convenient manner to use the device for time managements and managing upcoming tasks, bookings, meetings or other calendar events without specifically opening or operating any special calendar application or calendar device, such as opening a calendar application or the like in the smartphone or laptop. According to an embodiment the calendar or events data can be displayed visually in a similar way as with the outer device, like a mobile phone or computer. In addition the wristwatch may comprise a device for reset the wristwatch, such as a reset sunken button.

### BRIEF DESCRIPTION OF THE DRAWINGS

Next the invention will be described in greater detail with reference to exemplary embodiments in accordance with the accompanying drawings, in which:

FIG. 1 illustrates a principle of an exemplary wristwatch device and arrangement with a time management function according to an advantageous embodiment of the invention,

FIG. 2 illustrates an exemplary wristwatch device with a time management function according to an advantageous embodiment of the invention,

FIG. 3 illustrates exemplary wristwatch devices with a time management function according to an advantageous embodiment of the invention,

FIGS. 4A, 4B illustrate exemplary embodiment of selecting a period to be displayed in the wristwatch device according to an advantageous embodiment of the invention,

FIG. 5 illustrates exemplary embodiment of display segmentation of the wristwatch device according to an advantageous embodiment of the invention, and

FIG. 6 illustrates exemplary synchronization of the wristwatch device according to an advantageous embodiment of the invention.

### DETAILED DESCRIPTION

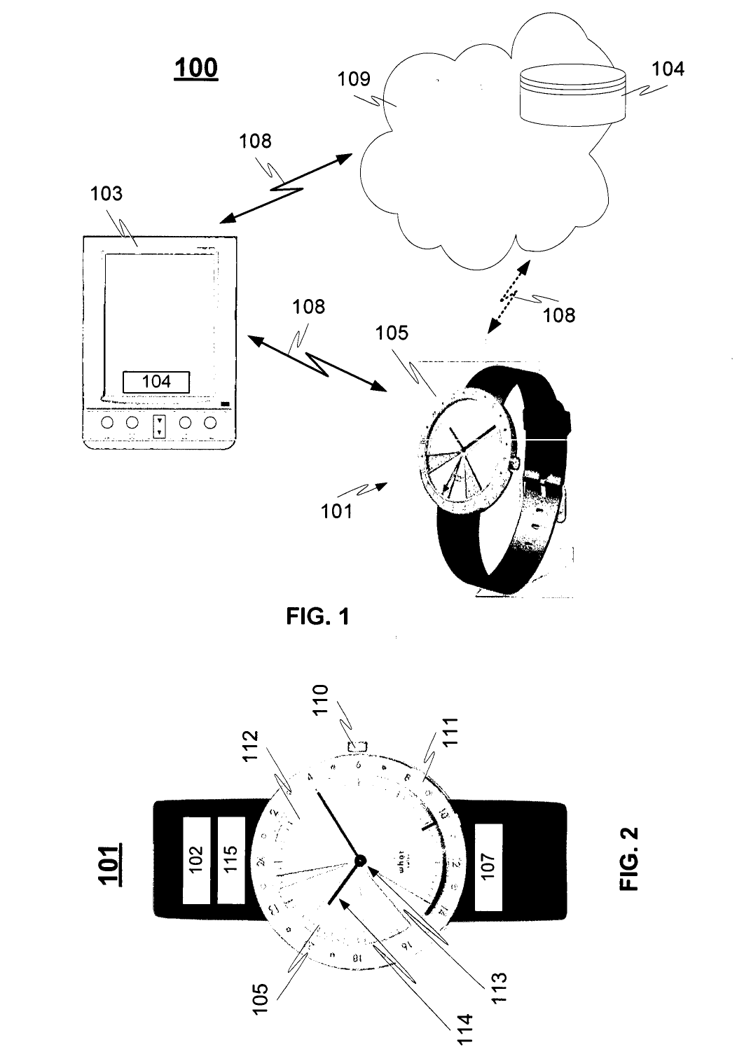

FIGS. 1 and 2 illustrate a principle of an exemplary wristwatch device 101 and arrangement 100 with a time management function according to an advantageous embodiment of the invention, where the wristwatch device 101 comprises a data communication device 102 for receiving 108 time management data from an outer device 103 comprising database or data storage 104 of time management data, advantageously for example schedule or calendar data in electronic form, and suitable program, network browser or application for controlling said data, such as adding or deleting events. The outer device 103, 109 may be for example a mobile terminal, such as mobile phone, smartphone, tablet computer, laptop computer, computer, wireless router, server or cloud based server provided with an Outlook, Google or Yahoo calendars, for example. The data communication link 108 may be a single or bi-directional data communication link 108 and is advantageously established between the wristwatch device and the first near outer device, such as device bring by the user, for example a smart phone 103 running the application. Additionally the smart phone 103 may establish additional data communication link 108 with another outer device, such as network cloud server 109. It is to be noted that the wristwatch device 101 may also establish (optionally) direct data communication link 108 via the router to the server 109, but in an advantageous embodiment the data link is one way from the outer device (from the application) to the wristwatch. By this e.g. energy can be saved, because the wristwatch is not sending data, only receiving, and in addition especially because the receiving is continuous.

The wristwatch device 101 comprises also a display device 105 having indication means 106, such as segments 106a, 106b, 106c, for indicating periods of time or timely arranged tasks of calendar bookings for example. The wristwatch device 101 comprises also a data controlling unit 107 configured to read the received 108 time management data so events in time and thereby control the indication means, such as segments of the display device in order to indicate said events in time, such as booked periods of time based on said received time management data.

The wristwatch device comprises advantageously also a user interface, such as a button 110, wheel or rotating bezel 111, touch sensor 112 or other types of sensors, such as acceleration 115, temperature, illumination, speed, altitude, position or the like sensor, where a certain pre-programmed function can be coupled so that when the user interface is manipulated or the measured parameter exceeds or deseeds a predetermined range, said pre-programmed function is performed. The pre-programmed function may be e.g. a message to be launched or sent, or changing the period to be displayed or skipping the alarm or reminder.

One option of the user interface is a control wheel 111, which can be arranged around the display 105, which can be coupled with an angle sensor for determining the angle of the wheel turned.

The wristwatch device may also comprise a quartz or mechanical movement and an axis 113 for the movement, and where the first end of the pin axis is advantageously connected to the quartz or mechanical movement and the second free end is provided for hands 114 of the wristwatch device for indicating time, as an example.

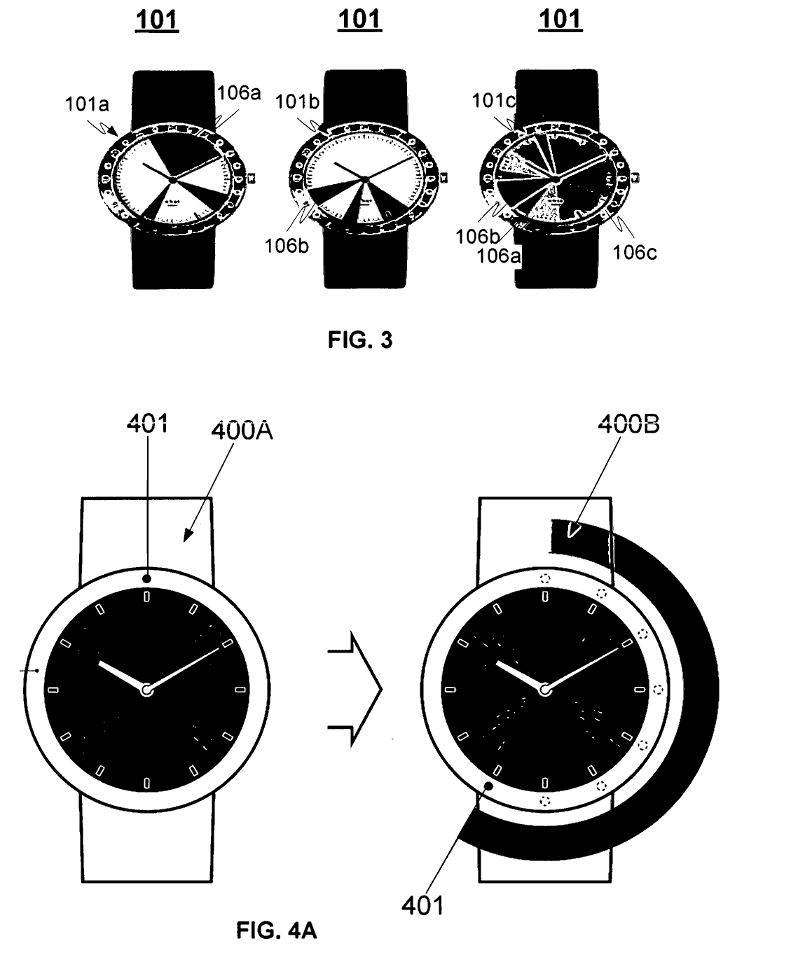

FIG. 3 illustrates exemplary wristwatch devices 101 with a time management function according to an advantageous embodiment of the invention, where the devices 101 have different view 101a, 101b, 101c in their displays 105. The data controlling unit of the wristwatch devices can be configured to manipulate and control the indication means, like segments of the display device differently for different levels of booking or other events. For example working bookings, timely tasks assignment, leisure-time bookings or priority bookings can be displayed in different manner, e.g. by different gray scale 106a, 106b, 106c in order to indicate different booked periods or natures of different events differently.

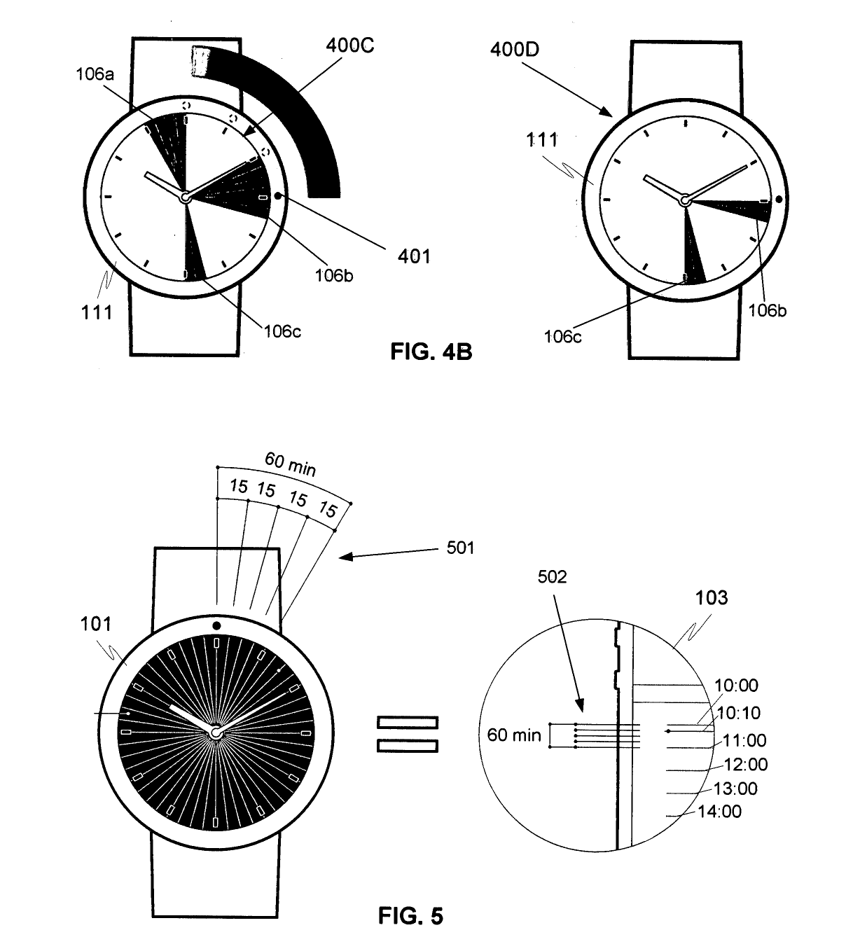

FIGS. 4A and 4B illustrate exemplary embodiment of selecting a period to be displayed in the wristwatch device according to an advantageous embodiment of the invention. The rotating wheel 111 has advantageously a clear position indicator e.g. with a tactile feedback, such as a “snap” feedback in every single segment when the when is turned. The wheel may click e.g. into a position every full hour, or the like. By rotating the wheel a period to be displayed can be selected, such as the next 12 hours.

For example in FIG. 4A the position indicator 401 points to 12 (400A), whereupon the schedule from 12 to 12 is displayed. When the wheel 111 is rotated so that the position indicator 401 points e.g. to 7 (400B), the schedule from 7 to 7 is displayed.

Another example is illustrated in FIG. 4B, where in 400C the position indicator 401 points to 12 and the scheduled events 106a, 106b, 106c can be seen for the next 12 hours starting from 12. Now when the wheel 111 is rotated (400D) so that the position indicator 401 points e.g. to 3, the scheduled events 106b, 106c for the next 12 hours starting from 3 is displayed. It is to be noted that only the remaining portion of the scheduled event 106b is displayed so the portion starting from the point indicated by the position indicator 401.

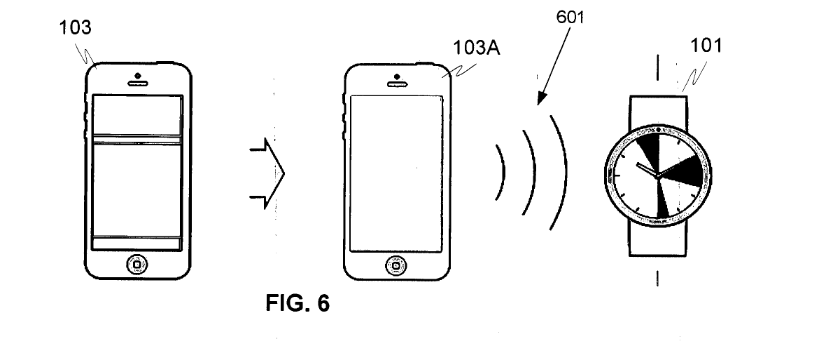

FIG. 5 illustrates exemplary embodiment of display segmentation of the wristwatch device according to an advantageous embodiment of the invention, where the wristwatch device comprises 4 segments (501) per hour (each 15 minutes), which corresponds the standard calendar periods (502) managed e.g. by the typical outer device 103. Thus the display device 105 comprises totally 48 segments. However, it is to be noted that this is only example and should not be understood as a limiting example.

FIG. 6 illustrates exemplary synchronization of the wristwatch device 101 according to an advantageous embodiment of the invention, where the user may manage his/her schedule e.g. by using typical calendar software or application in the mobile outer device 103. According to an example the method (application) of the invention is run background (103A), which constantly or after a certain time period (e.g. once in every 15 minutes) determines for the calendar application of the outer device 103. When it 103A determines any changes in the calendar, it advantageously pushes or otherwise transmits 601 the changes as said time management data to the wristwatch device 101. The wristwatch device 101 receives said data and update the display showing as disclosed elsewhere in this document so e.g. if a change has been detected the events will be added (or deleted) from the watch face (display). In addition advantageously the period starting from the selected point (selected by the indicator 401) is shown.

It is to be noted that the wristwatch device can automatically change for example the next day as long as the user has schedules in the calendar or other event when it is synced up. For example the website may be one of the most convenient places where users can sync their wristwatch devices with their calendars. If the users have their schedule set up for a week for example, they won't have to re-sync the wristwatch device for a week. Again it is to be noted that the whole day can be seen according to the invention as a graphical schedule pi-chart thereby providing own personal schedule as a custom face everyday design.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

1. A wristwatch device with a time management function for displaying a schedule in the wristwatch device, wherein the wristwatch device comprises:
a data communication device for receiving time management data from an outer device comprising data storage of time management data;
a display device comprising indication means for indicating schedule, periods of time or timely arranged events; and
a data controlling unit configured to read said received time management data and thereby manipulate said indication means of the display device in order to indicate the schedule, periods of time or timely arranged events based on said received time management data.

2. The wristwatch device of claim 1, wherein the outer device is one of the following: a mobile terminal, such as mobile phone, tablet computer, laptop computer, computer, wireless router, server or cloud based server, and wherein the calendar is an electronic or online calendar or task list holding computer program, which is configured to be manipulated via a browser, certain program or application.

3. The wristwatch device of claim 1, wherein the data communication device comprises Bluetooth, WIFI, 3G/4G, NFC, infra-red, data modulated visible light or wired data communication device configured to establish a single or bi-directional data communication link between said wristwatch device and the outer device.

4. The wristwatch device of claim 1, wherein the wristwatch device comprises a user interface coupled with a pre-programmed function, whereupon the wristwatch device is configured to perform said pre-programmed function when the user interface is manipulated, and wherein said pre-programmed function comprises a pre-programmed message, comprising an “Accept” or “Decline” message, or changing the period to be displayed.

5. The wristwatch device of claim 1, wherein the wristwatch device comprise a touch screen or tapping detecting device to detect tapping of the display or the wristwatch.

6. The wristwatch device of claim 1, wherein the wristwatch device comprises a control wheel around the display, whereupon a period of time is configured to be booked via manipulating said control wheel, and wherein the start of the period of time is configured to be selected by said wheel and marked by pressing a button, and the extent of the period and stop of the period is configured to be selected by turning said wheel and marked by pressing said button.

7. The wristwatch device of claim 1, wherein the wristwatch device comprises a control wheel around the display, whereupon a starting point of a period to be displayed is configured to be selected by manipulating said control wheel.

8. The wristwatch device of claim 4, wherein the wristwatch is configured to send data related to the selected pre-programmed function or period of time booked.

9. The wristwatch device of claim 7, wherein the wristwatch comprises an angle sensor configured to determine the angle of the wheel turned, whereupon the data controlling unit is configured to determine the selected period of time and indicate it via the display device.

10. The wristwatch device of claim 1, wherein the display device comprises an electrophoretic ink paper display, monochromatic display, grey-scale display, full colour, a reflective, transflective or transmissive TFT display (Thin-Film-Transistor display), OLED display (Organic Light-Emitting Diode), MEMS display, or a reflective display device comprising microscopic mirrors in each pixel of the display configured to change a size of an air gap inside the pixel and thereby interferometrically modulate white light to reflect back as different colours depending on the size of said air gap.

11. The wristwatch device of claim 1, wherein the display device comprises an integrated or a separate capacitive touch screen whereupon a period of time for a calendar or task is configured to be booked via manipulating said capacitive touch screen.

12. The wristwatch device of claim 1, wherein the wristwatch device comprises a quartz or mechanical movement and an axis for the movement is arranged through the hole in said display device, where the first end of the pin axis is connected to the quartz or mechanical movement and the second free end is provided for hands of the wristwatch device.

13. The wristwatch device of claim 1, wherein the data controlling unit is configured to manipulate said indication means, comprising segments of the display device differently for different levels of booking, comprising working bookings, timely tasks assignment, leisure-time bookings or priority bookings, in order to indicate different booked periods differently.

14. The wristwatch device of claim 1, wherein the wristwatch device comprises an energy source.

15. The wristwatch device of any of previous claim 1, wherein the wristwatch device comprises a chargeable battery supercapacitor and induction device configured to be coupled with an induction coil energy charging system, whereupon the wristwatch device is configured to charge said battery via induction.

16. The wristwatch device of claim 1, wherein the wristwatch device comprises a re-chargeable battery supercapacitor and energy harvesting device configured to harvest energy from the light, temperature difference or motion, whereupon the wristwatch device is configured to charge said battery via such harvesting device or their combination.

17. The wristwatch device of claims 1, wherein the wristwatch device is configured to display the next 12 hours or 24 hours bookings at a time.

18. The wristwatch device of claim 1, wherein the wristwatch device is configured to display different events with higher priorities in the different colours or different grey-scale level pre-defined by the user.

19. The wristwatch device of claim 1, wherein the wristwatch device is configured to be synchronized with the outer device so that at least one day or one week data is synchronized at a time, and wherein synchronization is configured to happened only if the calendar data at the database for the period in question has changed after previous synchronization.

20. The wristwatch device of claim 1, wherein the wristwatch device comprises a vibration device for providing a tactile feedback, comprising a vibrational alarm on an upcoming event or other booked time.

21. A method for providing a wristwatch device with a time management function for displaying a schedule in the wristwatch device,
wherein the method comprises:
receiving time management data by a data communication device of the wristwatch device from an outer device comprising data storage of time management data,
indicating schedule, periods of time or timely arranged tasks by a display device comprising indication means; and
reading said received time management data and thereby manipulating said indication means of the display device by a data controlling unit in order to indicate the schedule, periods of time or timely arranged events of time based on said received time management data.

22. (canceled)

23. The wristwatch device of claim 5, wherein the tapping detecting device comprises an accelerometer or microphone to detect tapping of the display or the wristwatch.

24. A wristwatch device of claim 14, wherein the energy source comprises a primary non-rechargeable battery.

25. A wristwatch device of claim 16, wherein the energy harvesting device comprises a solar cell, thermal element or induction device.
